(19) United States
(12) Patent Application Publication
(10) Pub. No.: US 2006/0276615 A1
(43) Pub. Date: Dec. 7, 2006

(54) Aminotriazine condensation product, use of an aminotriazine condensation products and method for the production of an aminotriazine condensation product

(75) Inventors: Christian Furst, Linz (AT); Michael Schadenbock, Enns (AT); Daniel Jocham, Linz (AT)

Correspondence Address: THE WEBB LAW FIRM, P.C., 700 KOPPERS BUILDING, 436 SEVENTH AVENUE, PITTSBURGH, PA, 15219, US

(73) Assignee: AMI AGROLINZ MELAMINE INTERNATIONAL GMBH, Linz (AT)

(21) Appl. No.: 10/550,861

(22) PCT Filed: Mar. 25, 2004
(86) PCT No.: PCT/EP04/03178

§ 371 Date: Aug. 16, 2006

(30) Foreign Application Priority Data
Mar. 26, 2003 (DE) 103144781
May 9, 2003 (DE) 103221077

(51) Int. Cl. C08G 14/02

(52) U.S. Cl. 528/129

(57) ABSTRACT

The invention relates to an aminotriazine condensation product, especially a melamine condensation product, produced by reacting aminotriazine, particularly melamine, with an oxocarboxylic acid derivative. The invention also relates to the use of the aminotriazine condensation product and to a method for the production thereof. The aminotriazine condensation product obtained offers a wide range of possible applications by virtue of the simple accessibility thereof for derivatizations and, by virtue of the absence of formaldehyde, the aminotriazine condensation product is more health-friendly than known condensation products.

The invention relates to an aminotriazine condensation product according to claim 1, to the use thereof according to claim 15 and to a method for producing it according to claim 16.

As a representative of the aminotriazines, melamine is of the greatest industrial importance. Melamine (I) is a very unreactive molecule and therefore only reacts with very reactive and consequently also hazardous substances (halogens, acid chlorides, concentrated nitric acid, cyanates, thiocyanates, alkyl sulfates; BASF, Technical Data Sheet for Melamine, 1969, 1-18). The condensation of melamine with aldehydes is likewise known, the reaction of melamine with formaldehyde being the only one of economic importance. From this form melamine-formaldehyde resins (Ullmann's Encyclopedia of Industrial Chemistry, (1987), Vol. A2, 130-131).

In this connection, it is disadvantageous that formaldehyde in particular is classified as being injurious to health (toxic, potentially carcinogenic) and that formaldehyde is a very reactive compound, meaning that its reactions can only be controlled with difficulty. Furthermore, the derivatizability of the primary reaction products of formaldehyde with melamine (methylol-melamine) is for the most part limited to etherification.

Reactions of glyoxylic acid and glyoxal with melamine are also known.

DE 42 17 181 A1, for example, describes the use of the condensation products of melamine and glyoxylic acid and

salts thereof as additive for hydraulic binders and building materials.

DE 41 40 899 A1 discloses a method for producing water-soluble condensation products from a mixture of melamine, glyoxylic acid and glyoxal. The condensation products obtained are used as tanning agents.

When reacting melamine with glyoxylic acid there is the disadvantage that a very unreactive melamine-glyoxylic acid salt is formed as a reaction product which is only accessible to subsequent derivatization with very great effort.

Glyoxal in turn polymerizes very readily to give poly-glyoxal and, at room temperature, is a highly irritative substance. The derivatizability of the primary reaction products with melamine is, as is the case with the use of formaldehyde, limited to etherification.

The object of the present invention is to provide a new type of formaldehyde-free aminotriazine condensation product, in particular a melamine condensation product which can be derivatized simply by a large number of chemical transformations and thus offers a large number of possible applications.

This object is achieved by an aminotriazine condensation product which can be produced by a condensation of an aminotriazine with at least one oxocarboxylic acid derivative.

Accordingly, the present invention provides an aminotriazine condensation product, in particular a melamine condensation product, which is characterized in that it can be produced by the reaction of an aminotriazine, in particular of

melamine, with at least one oxocarboxylic acid derivative.

Suitable aminotriazines are, for example, melamine, ammeline, ammelide and also substituted melamines, such as, for example, alkylated or hydroxyalkylated melamine. Particular preference is given to using melamine.

An oxocarboxylic acid derivative (II) is understood as meaning a compound which has not only at least one oxo group (—CO—) or a derivative of an oxo group, such as, for example, a hemiketal, hemiacetal, imine, hemiaminal, hemiamidal, and amino derivatives thereof, but also at least one derivative of a carboxyl group, such as, for example, an ester, amide, amidine, imino ester, nitrile, anhydride, and also the imino derivatives of the anhydride in the molecule.

Examples of oxocarboxylic acid derivatives are shown below: 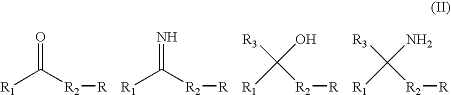
where R=ester —CO—OR₂, amide —CO—NH₂, substituted amide —CO—NR₁R₂, anhydride —CO—O—CO—R₁, nitrile —CN, imino ester —CNH—OR₂, amidine —CNH—NH₂, substituted amidine —CNH—NR₁R₂, imino derivatives of the anhydride —CNH—O—CO—R₁, —CNH—O—CNH—R₁ and —CNH—NH—CNH—R₁,
R₁=alkyl, alkenyl, alkynyl and/or aryl radicals and/or substituted alkyl, alkenyl, alkynyl and/or aryl radicals having up to 20 carbon atoms or hydrogen H,
R₂=alkyl, alkenyl, alkynyl and/or aryl radicals and/or substituted alkyl, alkenyl, alkynyl and/or aryl radicals having up to 20 carbon atoms,
R₃=—OR₁, —NH₂, —NR₁R₂, —R₁N—CO—R₁ (amide radical), —R₁N—CNH—R₁ (amidine radical), —R₁N—CN (cyanoamide radical), —R₁N—CNH—NH—CN (dicyanodiamide radical) and —R₁N—CNH—NR₁R₁ (guanidine radical).

The oxocarboxylic acid derivative is advantageously an oxocarboxylic ester (III) and/or a carboxylic ester hemiketal (IV), 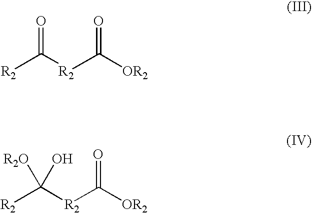
where the radicals R₂ may be identical or different.

For the R₂ in the neighboring position to the carbonyl group, preference is given to those which have no alpha-H, i.e. the C atom adjacent to the carbonyl group preferably has no bonded hydrogen atom.

The oxocarboxylic acid derivative is preferably an aldehydecarboxylic acid derivative, advantageously an aldehydecarboxylic ester (V) and/or a carboxylic ester hemiacetal (VI), 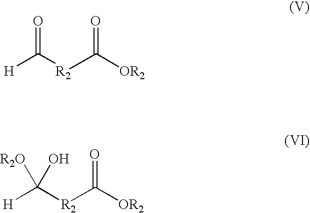
where the radicals R₂ may be identical or different.

For the R₂ in the neighboring position to the carbonyl group, preference is given to those which have no alpha-H, i.e. the C atom adjacent to the carbonyl group preferably has no bonded hydrogen atom.

The aldehydecarboxylic acid derivative is also advantageously a glyoxylic ester (VII) and/or a glyoxylic ester hemiacetal (VIII), 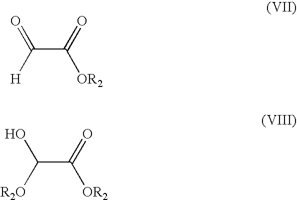
where the radicals R₂ may be identical or different.

In a particularly preferred embodiment, the aldehydecarboxylic acid derivative is glyoxylic methyl ester methyl hemiacetal (GMHA; methyl 2-hydroxy-2-methoxyacetate) (IX).

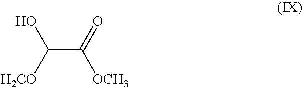

GMHA is a compound which is liquid at room temperature and which, under atmospheric pressure at temperatures of from about 122 to 124° C., polymerizes with the elimination of methanol.

Compared with formaldehyde, GMHA has substantially reduced reactivity.

Unexpectedly, GMHA reacts with melamine, with or without solvents and without the addition of a catalyst to give a syrup-like solution.

Whereas reactions of melamine with formaldehyde produce, on account of the high reactivity of the formaldehyde, a mixture of very different products with a varying degree of substitution, in the case of the reaction of melamine with GMHA, the controllability of the reaction is better.

In the case of the reaction of melamine with GMHA, in the primary reaction step, 2-hydroxy-2-melaminyl acetic methyl ester (methyloxycarbonylhydroxymethine melamine) (X) is formed with the elimination of methanol.

Multiple substitution on the melamine is possible since each NH₂ group can theoretically bond two GMHA units.

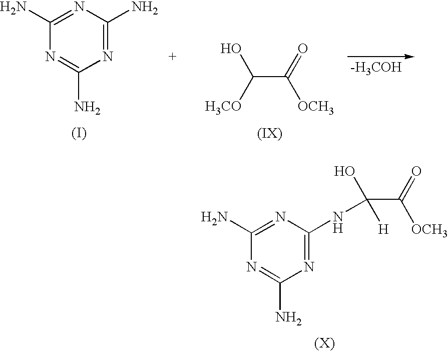

During the reaction of melamine with GMHA, it is surprisingly possible to use methanol as solvent. This is surprising since methanol should in fact promote the reverse reaction. Methanol is also therefore advantageous because the reaction products which form are soluble in methanol.

Under slightly acidic conditions with a pH between about pH=3 and pH=7, the methyl etherification of the hydroxy group, i.e. the reaction of 2-hydroxy-2-melaminyl acetic methyl ester (X) to 2-methoxy-2-melaminyl acetic methyl ester (XI), takes place in parallel to the primary reaction.

Moreover, 2-methoxy-2-melaminyl acetic methyl ester (XI) can also be prepared in a targeted manner by reaction of 2-hydroxy-2-melaminyl acetic methyl ester (X) with methanol under acidic conditions, i.e. through etherification.

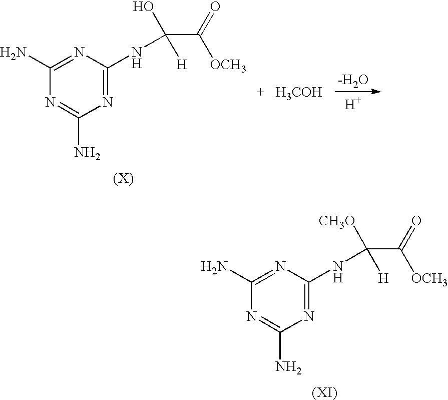

Analogously to melamine-formaldehyde resins, units joined together arise which also may be polysubstituted as well. Possible representatives with a so-called “methine bridge” or “methine-oxy-methine bridge” are depicted below:

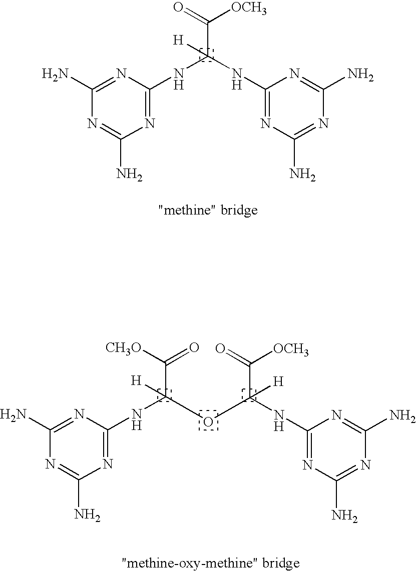

In an acidic medium, an equilibrium between compound (X) and (X′) is established which, on account of the stable, quasiaromatic melamine ring, lies on the side of (X). However, with longer reaction times and higher temperatures (X′) produces, as a result of the elimination of methanol (intermolecular amidation), the very stable and sparingly soluble bicycle (XII) (8-hydroxy-9-oxo-(4,5)-dihydroimidazo[2,1-b]-2,4-diamino-1,3,5-triazine).

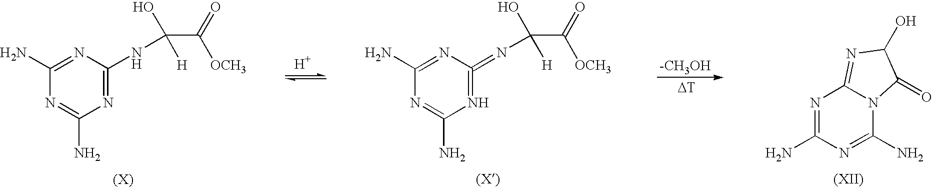

The reverse cleavage of the compound (XII) to give a derivative of (X) can be achieved through reaction with nucleophils, such as, for example, alcohols, water and amines, at elevated temperatures.

In the reaction of 3 GMHA units with melamine and subsequent cleaving off of methanol, the compound (XIII) (4,9,14-trihydroxy-5,10,15-trioxotris((4,5)-dihydroimidazo)[2,1-β;2′,1′-δ;;2″,1″-φ]-1,3,5-triazine) forms as limiting case.

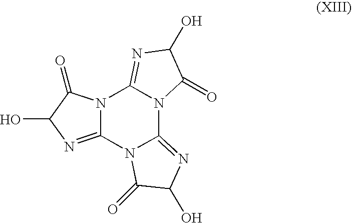

The compound (XII) reacts upon further heating with elimination to give the yellow-orange colored chromophore (XIV) (9-oxo-(2,5)-dihydroimidazo[2,1-β]-2-imino-4-amino-1,3,5-triazine).

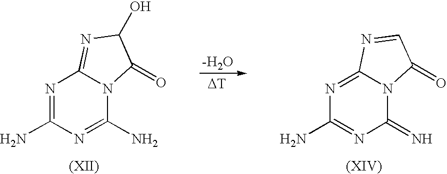

The aminotriazine condensation products according to the invention are prepared by the reaction of the aminotriazine with the oxocarboxylic acid derivative, preferably in a single-stage synthesis.

The molar ratio of aminotriazine to the oxocarboxylic acid derivative is about 1:1 to 1:6, preferably about 1:1.5 to 1:6, particularly preferably about 1:2.0 to 1:4.

It is also possible to react the aminotriazine in the presence of an alcohol with an oxocarboxylic acid itself so that an oxocarboxylic ester is formed in situ in the reaction mixture.

In a further embodiment of the invention, besides an aminotriazine and at least one oxocarboxylic acid derivative, formaldehyde and/or glyoxal and/or urea is also present in the reaction mixture.

The reactions of the aminotriazine with the oxocarboxylic acid derivative can take place without solvent, although they are preferably carried out in a solvent or in a solvent mixture. For this purpose, it is possible, for example, to use inert solvents, such as dimethyl sulfoxide, dimethylformamide or dioxane. Furthermore, it is in particular possible to use alcohols and/or water as solvent.

The primary reaction of the aminotriazine with the oxocarboxylic acid derivative can take place in the entire pH range from pH=0 to pH=14. Preferably, the reaction takes place in the pH range from about 3-10.

To adjust the pH, use may be made of customary acids, for example p-toluenesulfonic acid, amidosulfonic acid, glyoxylic acid, nitric acid, hydrochloric acid, sulfuric acid and bases, such as, for example, sodium hydroxide, potassium hydroxide, diethanolamine, triethanolamine, morpholine.

In the acidic range, besides the primary condensation of the aminotriazine with the oxocarboxylic acid derivative, secondary condensation reactions also occur.

The primary reaction of the aminotriazine with the oxocarboxylic acid derivative takes place in a temperature range from about 20 to 200° C., preferably from about 40 to 160° C. and in a pressure range from about 0 to 15 bar, preferably from about 0 to 5 bar superatmospheric pressure. The reaction time is between about 5 and 300 minutes, preferably between about 15 and 120 minutes.

The reaction is continued, for example, until the aminotriazine has dissolved or until the desired conversion. The conversion can be ascertained via customary analytical controls such as, for example, liquid chromatography, gas chromatography, and/or infrared spectroscopy and UV spectroscopy.

In contrast to the products obtained in the condensation of aminotriazines with formaldehyde, the primary reaction products of the reaction according to the invention are readily soluble both in organic solvents and also in water.

With the primary reaction products, secondary reactions such as, for example, etherification, transetherification, esterification, transesterification and also amidation or hydrolysis can easily be carried out, in which case secondary products (derivatives) are obtained from the aminotriazine condensation products.

In contrast to this, formaldehyde condensation products are limited for the most part to etherification and transetherification with regard to possible secondary reactions. In this way, starting from the aminotriazine condensation products according to the invention it is possible to prepare a large number of readily accessible derivatives.

Aminotriazine condensation products according to the invention are understood as meaning both the primary reaction products and also the possible secondary products of the primary reaction products, and mixtures of these two components.

It is possible to carry out the secondary reactions of the condensation products according to the invention in the same reaction step as the primary condensation of the aminotriazine with the oxocarboxylic acid derivative. Preferably, however, the secondary reactions of the condensation products according to the invention are carried out in a second reaction step.

If an etherification or transetherification, or an esterification or transesterification, is carried out simultaneously in parallel to the primary reaction of the aminotriazine with the oxocarboxylic acid derivative, the reaction is carried out in acidic conditions and an alcohol is used as a solvent which then also serves as reactant for the etherification or transetherification, or esterification or transesterification.

If the etherification or transetherification, or esterification or transesterification, is carried out in a separate second reaction step, the primary reaction product is introduced under acidic conditions into an alcohol or into alcohol-containing solvent mixture, the alcohol serving not only as solvent, but also as reactant for the etherification or transetherification, or esterification or transesterification.

The etherification or transetherification, or the esterification or transesterification, is in principle carried out under acidic conditions with a pH of less than 7, preferably in the pH range from about 3-6.5.

The reaction takes place in a temperature range from about 20 to 200° C., preferably from about 40 to 160° C. and in a pressure range from about −1 to 15 bar, preferably from about

−1 to 5 bar superatmospheric pressure. The reaction time is between about 5 and 300 minutes, preferably between about 15 and 120 minutes.

The reaction is continued, for example, until a solution is obtained or until the desired conversion. The conversion can be ascertained by customary analytical controls such as, for example, liquid chromatography, gas chromatography, and/or infrared spectroscopy and UV spectroscopy.

If the alcohol is used as reactant and/or solvent, it is used in an approximately 2- to 10-fold, preferably in an approximately 2- to 5-fold, molar excess, based on the groups to be modified.

If an alcohol is used for the etherification or transetherification or esterification or transesterification which boils at a higher temperature than the cleavage product, the cleavage product is preferably distilled off during the reaction.

If the alcohol boils at a very high temperature or does not boil at all, it may be used in the desired amount, for example in the required molar ratio, in dissolved form in an inert solvent.

The following alcohols are possible reactants for an etherification or transetherification or an esterification or transesterification: aliphatic or aromatic alcohols, diols or polyols; polyvinyl alcohols; pentaerythritol, dipentaerythritol; unsaturated alcohols, diols or polyols, for example allyl alcohol or hydroxyethyl methacrylate (HEMA); poly-, oligo-ethylene glycol derivatives, for example simulsols; oligo-, hydroxycarboxylic acid derivatives, for example caprolactone derivatives; poly-, oligo-ester polyols; poly-, oligo-lactides; sugars, sugar derivatives; starch, starch derivatives or cellulose derivatives.

The amidation of the aminotriazine condensation products according to the invention preferably takes place in a separate reaction step. It is carried out by introducing the primary reaction product of the aminotriazine with the oxocarboxylic acid derivative or else a secondary product, for example an etherified or transetherified or esterified or transesterified reaction product according to the invention, into an ammonia or amine solution.

The amidation is carried out with an approximately 2- to 3-fold molar excess of ammonia or amine, based on the carboxylic acid functionality. The amines used are, for example, primary or secondary aliphatic or aromatic amines. The amines are preferably used in dissolved form in a solvent, where water or alcohols, for example, may serve as solvents. They can, however, also be used as pure substances where the amine itself then functions as solvent. The pH during the reaction is alkaline with a pH value greater than 7, preferably between about 8 and 14. It is determined by the type and concentration of the amine used.

The reaction takes place in a temperature range from about 20 to 200° C., preferably from about 20 to 140° C. and in a pressure range from about 0 to 15 bar, preferably from about 0 to 5 bar superatmospheric pressure. The reaction time is between about 5 and 600 minutes, preferably between about 30 and 300 minutes.

The reaction is continued, for example, until the carboxamide crystallizes out or until the desired conversion. The conversion can be ascertained via customary analytical controls, such as, for example, liquid chromatography, gas chromatography, and/or infrared and UV spectroscopy.

Partial or complete hydrolysis of the carboxylic acid functionality of the primary reaction product of the

aminotriazine with the oxocarboxylic acid derivative results in compounds with a betaine structure (zwitterions). The compounds obtained in this way can be reversibly liquefied by heating to give a melt. Upon cooling, the compounds solidify in a salt-like manner to give a hard clump.

The hydrolysis is carried out with an approximately 2- to 5-fold molar excess of water, based on the carboxylic acid functionality.

For example, during the hydrolysis of a methyl ester, the methanol which forms is distilled off.

The hydrolysis can be carried out in the entire pH range from 0 to 14, although the hydrolysis is preferably carried out in the acidic pH range between 4 and 6.5.

The reaction takes place in a temperature range from about 20 to 200° C., preferably from about 20 to 140° C. and in a pressure range from about 0 to 15 bar, preferably from about 0 to 5 bar superatmospheric pressure. The reaction time is between about 5 and 600 minutes, preferably between about 30 and 300 minutes.

The reaction is continued until the desired conversion. The conversion can be ascertained via customary analytical controls, such as, for example, liquid chromatography, gas chromatography, and/or infrared and UV spectroscopy.

Both after the primary reaction of the aminotriazine with the oxocarboxylic acid derivative and also after possible secondary reactions of the aminotriazine condensation products, syrup-like solutions are obtained whose contents of reaction products are between about 5 and 95% by weight, preferably between about 25 and 75% by weight and particularly preferably between about 30 and 60% by weight.

The reaction products according to the invention can be completely or partially dissolved, it being possible for them to be present in the solid or liquid state of aggregation.

For work-up, the resulting solutions can be concentrated or made solvent-free by means of distillation under reduced pressure. This takes place, for example, in stirred reactors with distillation attachment, in thin-film evaporators or in film truders.

Should the aminotriazine condensation products be produced completely or partially as solid products, these are separated off by filtration and dried by means of reduced pressure or dry nitrogen with an increase in temperature.

The concentrated and/or solvent-free reaction products can be further condensed, for example, in an extruder, with an increase in temperature to about 250° C. After leaving the extruder, the melt obtained in this way is cooled and formulated during cooling.

The aminotriazine condensation products according to the invention can be further condensed and/or cured through the effect of temperature. The curing can take place in all pH ranges. Preferably, the products are cured in the acidic pH range from about pH 3-6.5. The temperatures during curing are about 90 to 250° C., preferably about 140 to 190° C. The curing operation lasts about 0.5 to 30 minutes, preferably about 3 to 10 minutes.

Aminotriazine condensation products according to the invention which comprise unsaturated structural units, such as, for example, C═C double bonds can be crosslinked by free-radical or ionic polymerization. The polymerization can be carried out as homopolymerization or else in mixtures with other unsaturated monomers, such as, for example,

acrylates, unsaturated polyesters or styrenes, as block polymerization or copolymerization. The initiators used for the polymerization may be diazo compounds, peroxides, ionic compounds and also UV light.

One advantage of the aminotriazine condensation products according to the invention is that they are free from formaldehyde. The problem of liberated formaldehyde known from conventional aminotriazine condensation products does not arise with the novel aminotriazine condensation products according to the invention.

GMHA as oxocarboxylic acid derivative for example has nowhere near the health risk of formaldehyde. GMHA is industrially available, it is a liquid which is soluble both in water and also in the customary organic solvents.

By contrast, formaldehyde is a gas which is available industrially almost exclusively in the form of an aqueous solution or in the form of solid, very sparingly soluble paraformaldehyde. For this reason, the majority of formaldehyde resins are either limited to aqueous systems, or paraformaldehyde has to firstly be made accessible to the reactants through an additional reactive depolymerization step to formaldehyde.

A further decisive advantage of the new type of aminotriazine condensation products according to the invention compared with customary formaldehyde-aminotriazine condensation products has its basis in the functional groups introduced via the oxocarboxylic acid derivative into the condensation product and ultimately also into the aminotriazine.

In a simple manner they permit the preparation of new types of aminotriazine condensation products with a large range of structures and derivatives, such as, for example, esters, amides, ethers, etherpolyols, esterpolyols, and physical properties, such as, for example, solid or liquid state of aggregation, hydrophobic or hydrophilic properties.

By contrast, formaldehyde-aminotriazine condensation products are largely limited to etherification and transetherification reactions due to the lack of functionality of the formaldehyde.

The aminotriazine condensation products according to the invention can be used for producing resins, such as, for example, impregnating resins, composite resins, compression molding material resins, hybrid resins with melamine-formaldehyde, acrylic, epoxy, polyurethane, unsaturated polyester and alkyd resins, resin additives, resin liquor stabilizers, (latent) hardeners, adhesives, foams, fibers, microcapsules, moldings, laminates, coating modifiers, crosslinkers, coating additives, materials with flameresistant properties and chromatography materials. In addition, they can be used as organic synthesis building blocks for specialty chemicals and pharmaceuticals or as polymer modifiers and agrochemicals. Moreover, the products according to the invention have potential in the field of UV protection and skincare products.

Via the carboxylic acid functionality of derivatives of the aminotriazine condensation products according to the invention, the incorporation into a large number of polymers is possible. For example, through etherification or transetherification or esterification or transesterification (X) with diols or polyols, such as, for example, ethylene glycol or polyethylene glycol derivatives, incorporation of such derivatives by condensation during the polyester preparation is possible.

A further application of the aminotriazine condensation products according to the invention consists in the mixing and chemical reaction with (un)modified melamine-formaldehyde resins, with epoxy resins, polyurethane resins, unsaturated polyester resins and alkyd resins for producing hybrid resin systems.

By reacting unsaturated aminotriazine condensation products according to the invention with acrylates, unsaturated polyesters or styrenes by free-radical or ionic polymerization it is possible to produce new types of copolymers with, for example, enhanced flame resistance.

By virtue of the possibility of being able to produce anhydrous products of the aminotriazine condensation products according to the invention, a reaction with isocyanates to give polyurethanes can take place without problems and, as a result, the aminotriazine can be reactively incorporated into the polyurethane network.

A further field of use primarily for the diol- or polyol-modified aminotriazine condensation products are intumescent flame retardant systems.

The reaction products of the reaction according to the invention are primarily chiral compounds which can themselves be constructed to give polymers or can be incorporated into other polymers, such as, for example, polyesters. The chiral polymers obtained as a result can be used for separating racemic mixtures.

### EXAMPLES

### Example 1

### Reaction of GMHA with Melamine in Methanol

126 g of melamine (1 mol), 360 g of GMHA (3 mol) and 250 g of methanol (7.8 mol) are initially introduced into a flask fitted with stirrer and reflux condenser. The pH is about 4.5. The suspension is heated to reflux with stirring for 60 minutes. During this, a clear solution of the melamine condensation products according to the invention is formed with a solids content of about 53% by weight. After the solvent has been evaporated off under reduced pressure, a mass remains which is highly viscous at room temperature and which is soluble in alcohols, water, acetone and esters.

### Example 2

### Reaction of GMHA with Melamine in Methanol

126 g of melamine (1 mol), 360 g of GMHA (3 mol) and 145 g of methanol (4.5 mol) are initially introduced into a flask fitted with stirrer and reflux condenser. The pH is about 4.5. The suspension is heated to reflux with stirring until everything has dissolved. During this, a solution of the melamine condensation products according to the invention analogous to XI is formed with a solids content of about 53% by weight. After the solvent has been evaporated off under reduced pressure, a mass remains which is highly viscous at room temperature and which is soluble in alcohols, water, acetone and esters.

### Example 3

### Reaction of GMHA with Melamine in Butanol

126 g of melamine (1 mol), 360 g of GMHA (3 mol) and 580 g of butanol (7.8 mol) are initially introduced into a flask fitted with stirrer and reflux condenser. The pH is about 4.5. The suspension is heated to reflux with stirring for 60 minutes. During this, a clear solution of the melamine condensation products according to the invention is formed with a solids content of about 50% by weight. After the solvent has been evaporated off

under reduced pressure, a mass remains which is highly viscous at room temperature and which is soluble in butanol, acetone and esters (insoluble in methanol, water).

### Example 4

### Reaction of GMHA with Melamine in n-butanol

126 g of melamine (1 mol), 360 g of GMHA (3 mol) are initially introduced into a flask fitted with stirrer and reflux condenser. The pH is about 4.5. The suspension is heated to about 50° C. with stirring. After 10 minutes, 580 g of n-butanol (7.8 mol) are added to the low-viscosity suspension and heated to reflux until a clear solution is formed. After the solvent has been evaporated off under reduced pressure, a mass, highly viscous at room temperature, of inventive condensation products transetherified/transesterified with n-butanol which are soluble in butanol, acetone and esters (insoluble in methanol, water) remains.

### Example 5

### Partial Transetherification/Transesterification of the Reaction Product from Example 3 with Simulsol BPLE

300 g of solvent-free reaction product from Example 3 are dissolved with stirring in 180 g of simulsol BPLE (2 OH groups per molecule, M=490 g/mol) at 60° C. The pH is about 5. The reaction mixture is heated to about 120° C. and about 42 g of butanol are distilled off under reduced pressure. During this, the reaction mixture becomes very viscous. On account of the stoichiometry, one fifth of all ether and ester groups is transetherified/transesterified with simulsol. The reaction product has gum-like viscosity at room temperature and is soluble in acetone.

### Example 6

### Amidation of the Reaction Product from Example 1 with Ammonia

130 g of solvent-free reaction product from Example 1 are dissolved in 200 ml of 25% by weight ammonia (2.7 mol) at 40° C.,

with a white precipitate precipitating out after a short time. It is stirred for a further 2 hours at about 25-30° C. The precipitate is filtered off and dried at about 60° C. under reduced pressure. Yield about 105 g of amide (91%). The product melts under a further reaction from 160° C.

### Example 7

### Reaction of the Reaction Product from Example 2 with n-butanol

In a flask fitted with stirrer and distillation bridge, 215 g of the solvent-free reaction product from Example 2 are introduced into 370 g of n-butanol (5 mol). The milky opaque mixture is heated to reflux in 15 minutes, during which a mixture of methanol/butanol then slowly distills over. After a further reaction time of about 10 minutes, a clear solution is formed. After a further 5 minutes, the solution is cooled and all of the solvent is distilled off under reduced pressure. That which remains is a mass, highly viscous at room temperature, of inventive condensation products transetherified/transesterified with n-butanol which are soluble in butanol, acetone and esters (insoluble in methanol, water).

### Example 8

### Reaction of Melamine with GMHA in the Melt

126 g of melamine (1 mol) and 240 g of GMHA (2 mol) are initially introduced into a flask fitted with stirrer and reflux condenser. The pH is about 4.5. The suspension is slowly heated with stirring until everything has dissolved, during which the suspension converts from high-viscosity via low-viscosity and then again to high-viscosity and methanol is formed as a product of the reaction. Duration about 35 minutes. After evaporating off the methanol under reduced pressure, a reversibly melting mass of condensation products according to the invention analogous to X which is hard at room temperature remains. The product is not very soluble in alcohols. Although the product is soluble in water, hydrolysis takes place (see Example 9).

### Example 9

### Hydrolysis of the Reaction Product from Example 8

280 g of reaction product from Example 8 are melted at 80° C. with stirring in a flask fitted with reflux condenser and admixed with 100 g of water. The pH is about 4.5. Within 10 minutes, the two phases combine to form a clear solution. Methanol is cleaved off. After reaction time of a further 10 minutes, the solution is cooled and the solvent is distilled off under reduced pressure. The residue is reversibly meltable and solidifies like a salt as a hard mass (betaine structure). The product is soluble in water.

### Example 10

### Reaction of the Reaction Product from Example 7 with HEMA (Hydroxyethyl Methacrylate)

320 g of solvent-free reaction product from Example 7 are heated to 100° C. with 200 g of HEMA (1.5 mol) and 0.3 g of a HALS compound (sterically hindered amine) as polymerization inhibitor with stirring in a flask. About 140 g of butanol are distilled off under reduced pressure over the course of 30 minutes. After cooling, inventive condensation products transetherified/transesterified with HEMA which are highly viscous at room temperature and are soluble in styrene remain.

1-18. (canceled)

19. An aminotriazine condensation product, such as a melamine condensation product,
produced by the reaction of an aminotriazine, such as melamine, with at least one oxocarboxylic acid derivative.

20. The aminotriazine condensation product as claimed in claim 19, wherein the at least one oxocarboxylic acid derivative originates from the group of the following compounds: 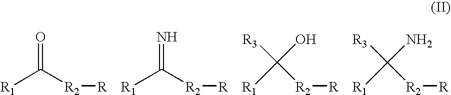
wherein R=ester (—CO—OR₂), amide (—CO—NH₂), substituted amide (—CO—NR₁R₂), anhydride (—CO—O—CO—R₁), nitrile (—CN), imino ester (—CNH—OR₂), amidine (—CNH—NH₂), substituted amidine (—CNH—NR₁R₂), or imino derivatives of the anhydride —CNH—O—CO—R₁, —CNH—O—CNH—R₁ and —CNH—NH—CNH—R₁,
R₁=alkyl, alkenyl, alkynyl and/or aryl radicals and/or substituted alkyl, alkenyl, alkynyl and/or aryl radicals having up to 20 carbon atoms or hydrogen H,
R₂=alkyl, alkenyl, alkynyl and/or aryl radicals and/or substituted alkyl, alkenyl, alkynyl and/or aryl radicals having up to 20 carbon atoms,
R₃=—OR₁, —NH₂, —NR₁R₂, —R₁N—CO—R₁ (amide radical), —R₁N—CNH—R₁ (amidine radical), —R₁N—CN (cyanoamide radical), —R₁N—CNH—NH—CN (dicyanodiamide radical), or —R₁N—CNH—NR₁R₁ (guanidine radical).

21. The aminotriazine condensation product as claimed in claim 19,
wherein
at least one oxocarboxylic acid derivative is an oxocarboxylic ester (III) or a carboxylic ester hemiketal (IV), 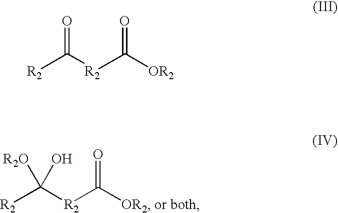
or both,
where R₂ may be identical or different.

22. The aminotriazine condensation product as claimed in claim 19,
wherein
at least one oxocarboxylic acid derivative is an aldehydecarboxylic ester (V) or a carboxylic ester hemiacetal (VI), 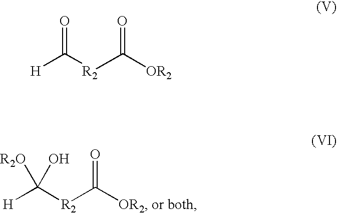
or both,
where R₂ may be identical or different.

23. The aminotriazine condensation product as claimed in claim 19,
wherein
at least one oxocarboxylic acid derivative is a glyoxylic ester (VII) or a glyoxylic ester hemiacetal (VIII), 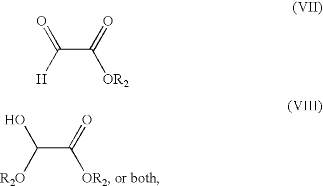
where R₂ may be identical or different.

24. The aminotriazine condensation product as claimed in claim 19, wherein at least one oxocarboxylic acid derivative is glyoxylic methyl ester methyl hemiacetal.

25. The aminotriazine condensation product as claimed in claim 19 wherein the molar ratio of aminotriazine to the oxocarboxylic acid derivative is 1:2 to 1:4.

26. The aminotriazine condensation product as claimed in claim 19, wherein the reaction is carried out in a solvent, such as water, alcohol or an inert solvent.

27. The aminotriazine condensation product as claimed in claim 19 wherein the reaction takes place at pH=3 to 10.

28. The aminotriazine condensation product as claimed in claim 19, wherein the condensation product is soluble both in organic solvents and also in water.

29. The aminotriazine condensation product as claimed in claim 19, wherein it is formed by secondary reactions which occur at the same time as or following the primary reaction or both.

30. The aminotriazine condensation product as claimed in claim 29, wherein the secondary reaction is an etherification, a transetherification, an esterification, a transesterification, an amidation or a hydrolysis.

31. The aminotriazine condensation product as claimed in claim 29, wherein the secondary reaction is carried out following the primary reaction.

32. The aminotriazine condensation product as claimed in claim 19, wherein, after the reaction, syrup-like solutions with a content of from about 5 to 95% by weight, such as from about 25 to 75% by weight, such as from about 30 to 60% by weight, are obtained.

33. A method for the production of aminotriazine condensation products as claimed in claim 19, wherein an aminotriazine, such as melamine, is reacted in a liquid phase with at least one oxocarboxylic acid derivative.

34. The method as claimed in claim 33, wherein, after the primary reaction, a derivatization, in particular an etherification, a transetherification, an esterification, a transesterification, an amidation or a hydrolysis, is carried out.

35. The method as claimed in claim 33, wherein the reaction product is at least one selected from the group consisting of concentrated, filtered off, dried, further condensed by increasing the temperature and cured.

36. The method as claimed in claim 34, wherein the reaction product is at least one selected from the group consisting of concentrated, filtered off, dried, further condensed by increasing the temperature and cured.
